(19) United States
(12) Patent Application Publication
(10) Pub. No.: US 2015/0175088 A1
(43) Pub. Date: Jun. 25, 2015

(54) Extendable Surround Image Capture System for Vehicles

(71) Applicant: Teddy Chang, Hacienda Heights, CA (US)

(72) Inventor: Teddy Chang, Hacienda Heights, CA (US)

(21) Appl. No.: 14/138,142

(22) Filed: Dec. 23, 2013

(51) Int. Cl. B60R 11/04; H04N 7/18; G03B 17/56

(52) U.S. Cl. CPC B60R 11/04; G03B 17/561; H04N 7/181

(57) ABSTRACT

An extendable surround image capture system having an image capture device or a video capture device mounted on an extension apparatus. The extension apparatus is capable of extending beyond the edges of the vehicle, thus allowing the image capture device to have at least a 180° view angle.

### BACKGROUND OF THE INVENTION

1. Field of Invention

The present invention relates to an extendable surround image capture system, and more particularly, an image capture device mounted on an extension apparatus fitted onto a vehicle, such as cars, trucks, watercraft, and aircraft. The extendable surround image capture system can be equipped with sensors, and visual and/or audio alert signals.

2. Related Art

A variety of vehicle-mounted image and video capture systems are available for vehicles. These image capture systems allow drivers to see areas outside their vehicles by transmitting the captured images in real time to a display located in the interior of the vehicle, such as on the vehicle dashboard. For example, many of these systems are mounted on the rear of vehicles to show drivers the area behind their vehicles as they are reversing the vehicle, thus helping to prevent accidents.

One of the disadvantages of vehicle-mounted image capture systems was limited scope of view. Currently, the primary solutions to this issue are to use multiple cameras and/or cameras with wide angle capabilities, such as those equipped with fisheye lenses. For example, U.S. Pat. No. 8,130,270 discussed using a vehicle-mounted image capture system of multiple cameras equipped with fisheye lenses. However, due to the fact that the cameras lenses are fitted at or near the surfaces of the vehicle exterior, these image capture systems still resulted in large blind spots, especially within the area immediately next to the vehicle.

Accordingly, there is a need for a vehicle-mounted image capture system capable of capturing images around the vehicle, including the area immediately next to the vehicle.

All patents, patent applications, articles, books, specifications, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

### SUMMARY OF THE INVENTION

It is an object of the invention to overcome the disadvantages of the prior art discussed above.

It is another object of the invention to provide a vehicle-mounted image capture system that can capture images around the immediate vicinity of the vehicle.

It is another object of the invention to provide a vehicle-mounted image capture system capable of capturing a wide angle view, preferably more than 180° view angle.

It is another object of the invention to provide a compact extendable image capture system for vehicles.

It is another object of the invention to assist drivers during certain driving maneuvers and to prevent accidents.

It is another object of the invention to alert pedestrians and other drivers of a driver's intent to make a maneuver.

It is another object of the invention to provide a simple, efficient, durable, and cost effective extendable surround image capture system for vehicles.

To address the aforementioned objectives and other objectives that will become apparent from the description of the invention, the present invention provides a surround image capture system with an extension apparatus with additional visual and/or audio alert signals.

One embodiment of the present invention utilizes a sliding bar, which is secured onto the vehicle by a bracket. One or more cameras are provided near a distal end of the bar. The bar can slide from a retracted position to an extended position. When in the extended position, the camera is positioned beyond the edge of the vehicle and is capable of capturing images of the area directly behind the vehicle, preferably more than 180° view angle.

A second embodiment of the present invention utilizes an extendable and retractable apparatus, such as a telescopic extension. A proximal end of the extension is affixed to the vehicle, while one or more cameras are provided near a distal end of the extension. When in use, the extension deploys from a retracted position to an extended position. For example, if the vehicle is in reverse, the extension moves to the extended position such that the camera reaches past the back end of the vehicle, thereby allowing the camera to capture images of the area directly behind the vehicle.

Another embodiment of the present invention utilizes a swing arm extension. As with the previous embodiment, one or more cameras are provided near a distal end of the swing arm extension and a proximal end of the extension is affixed to the vehicle. However, rather than extending and retracting, the swing arm extension swings the camera about one or more pivot points and swings the camera off the edge of the vehicle.

### BRIEF DESCRIPTION OF THE DRAWINGS

FIG. 1 is a side view illustrating a preferred embodiment of the present invention with one image capture device.

FIG. 2 is a side view illustrating a preferred embodiment of the present invention with two image capture devices.

FIG. 3 is a side view illustrating a preferred embodiment of the present invention with the sliding bar in a retracted position.

FIG. 4 is a side view illustrating a preferred embodiment of the present invention with the sliding bar in an extended position.

FIG. 5 is a side view illustrating a preferred embodiment of the present invention with the telescopic extension in a retracted position.

FIG. 6 is a side view illustrating a preferred embodiment of the present invention with the telescopic extension in an extended position.

FIG. 7 is a top view illustrating a preferred embodiment of the present invention with the swing arm extension in a retracted position.

FIG. 8 is a top view illustrating a preferred embodiment of the present invention with the swing arm extension in an extended position with the swing arm pointed toward the side.

FIG. 9 is a top view illustrating a preferred embodiment of the present invention with the swing arm extension in an extended position with the swing arm pointed toward the back.

### DETAILED DESCRIPTION OF THE INVENTION

Referring to the drawings, a description will be made with regards to preferred embodiments of an extendable surround image capture system according to the present invention.

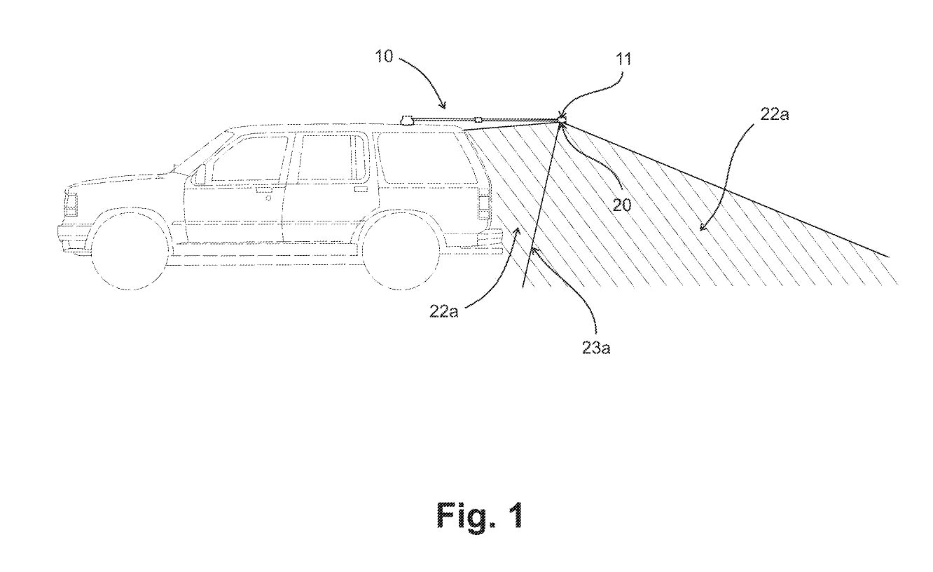

FIG. 1 shows one preferred embodiment of the present invention mounted on a vehicle. One or more image or video capture devices, such as a camera 20, are provided on a distal end 11 of an extension device 10. The extension device 10 is capable of extending to an appropriate length and positioning the camera 20 away from the vehicle and beyond the edge of the vehicle. This allows the camera 20 to capture a fuller view of the immediate vicinity around the vehicle, preferably more than 180° view angle.

The extension device 10 can be affixed on the surface of the vehicle, or placed in a recessed or hollowed section of the vehicle. One skilled in the art will recognize that the extension device 10 can be placed anywhere on the vehicle as appropriate. For example, for use as a rear view image capture system, the extension device 10 can be deployed toward the back of the vehicle and can sit atop the vehicle, be secured beneath the vehicle, be housed within the vehicle, or otherwise be placed so that the extension can be deployed behind the vehicle. When the driver is ready to reverse the vehicle, the system can be manually or automatically deployed to an extended position. A sensor is provided, preferably on the distal end 11, to determine whether there is enough space to deploy the extension device 10. In addition, lights and/or speakers can be provided on the extension device 10 to emit warning lights and sounds, respectively.

When the extension device 10 is in the extended position, at least one camera 20 is moved beyond the back edge of the vehicle. When appropriately positioned, the camera 20 is capable of capturing images of the area immediately behind the vehicle within the camera's scope of view 22a.

The extendable surround image capture system can be similarly used for other sides of the vehicle when the extension device 10 and/or the camera 20 are appropriately positioned around the vehicle. In some embodiments of the invention, the extension device 10 and/or the camera 20 can be remotely controlled by the driver to obtain the desired view. Captured images and videos are then preferably transmitted in real time, either wirelessly or by wire, to a display near the driver.

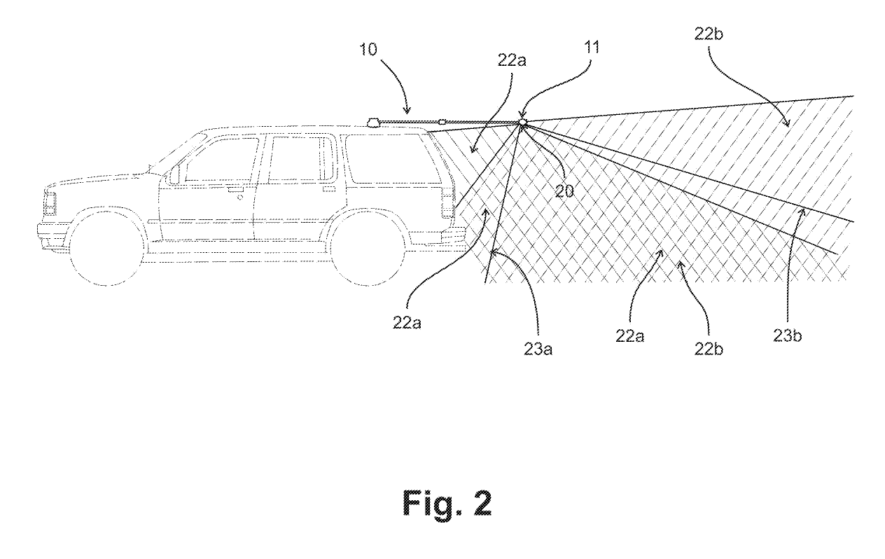

FIG. 2 shows a preferred embodiment of the present invention utilizing two cameras 20 positioned at a distal end 11. The use of additional cameras can capture a wider scope of view. One skilled in the art will recognize that the positioning of the cameras 20 is not restricted to the distal end 11 of the extension device 10. While this preferred embodiment positions both cameras 20 at the distal end 11, one or more cameras 20 can be positioned anywhere along the extension device 10, on the vehicle itself, or elsewhere, depending on the requirements of the application. In embodiments of the invention where a first scope of view 22a of one or more of the cameras 20 intersects with a second scope of view 22b of another camera 20, an image processor can be used to combine in real time the images captured within the scopes of view 22a and 22b to form one combined image. The combined image can then be relayed in real time to a display.

Various arrangements of the cameras 20 can be provided depending on the vehicle dimensions, environmental conditions, or requirements of a particular application. For example, in the two camera arrangement depicted in FIG. 2, a first center beam 23a of the first scope of view 22a is directed at a downward angle slightly toward the vehicle, while a second center beam 23b of the second scope of view 22b is directed at a downward angle slightly away from the vehicle. To provide a longer range view, the second center beam 23b can be pointed at an angle further away from the vehicle. Similarly, to provide a wider scope of view, the second center beam 23b can be pointed at an angle further away from the first center beam 23a.

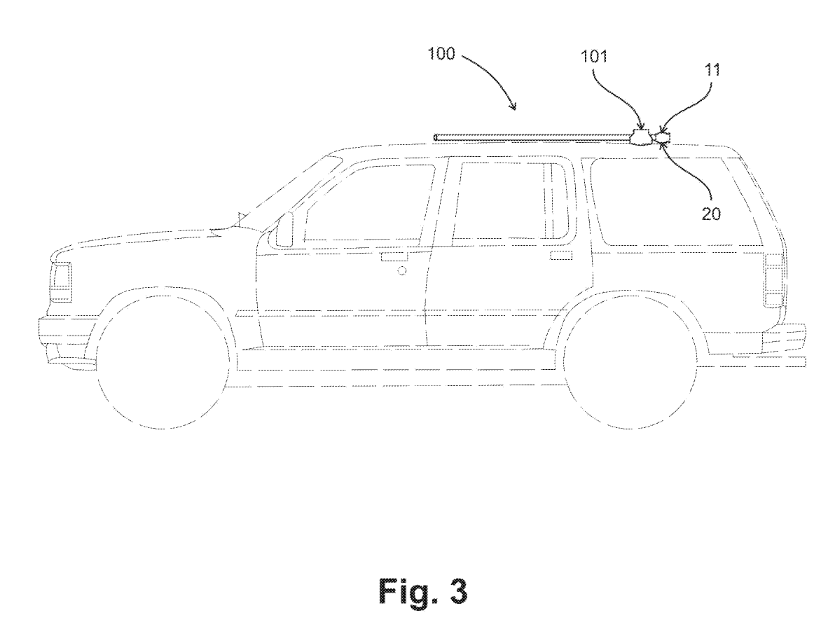

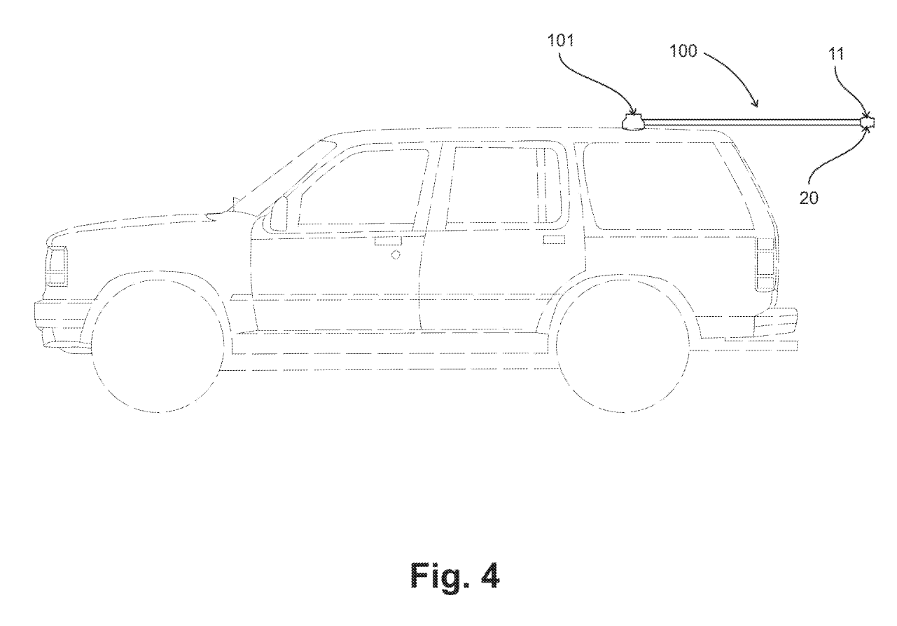

FIGS. 3 and 4 depict a preferred embodiment of a rear view image capture system according to the present invention using a sliding bar 100 as the extension device. The sliding bar 100 is secured onto the vehicle by a bracket 101 and is capable of deploying to an appropriate length. Upon deployment of the sliding bar 100 as shown in FIG. 4, a camera 20 located at a distal end 11 is moved away from the back edge of the vehicle. When not in use, the sliding bar 100 is stored in a retracted position as shown in FIG. 3.

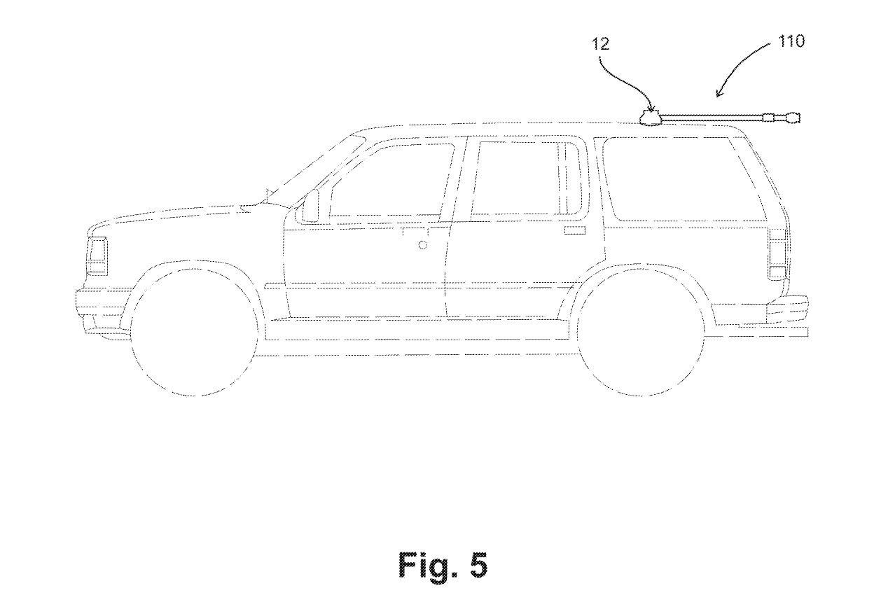

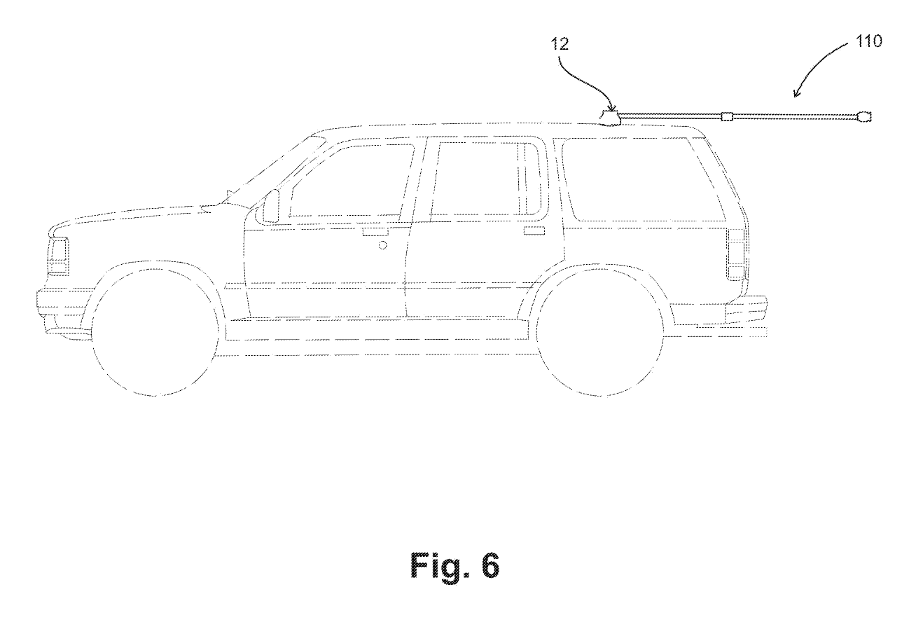

FIGS. 5 and 6 depict a preferred embodiment of a rear view image capture system according to the present invention using a telescopic extension 110 as the extension device. The proximal end 12 of the telescopic extension 110 is fixedly attached to the vehicle. As with the sliding bar, the telescopic extension 110 deploys into an extended position when the driver intends to reverse the vehicle and returns back to the retracted position when not in use.

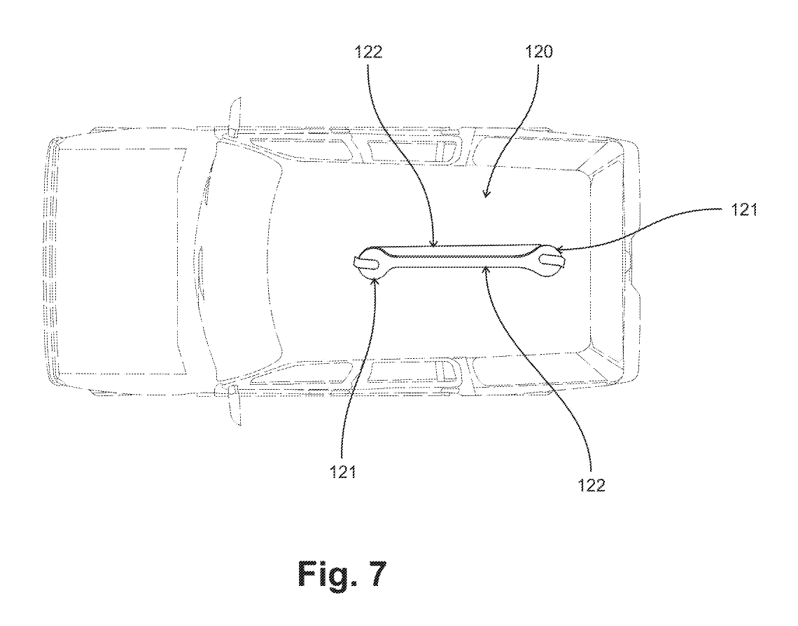

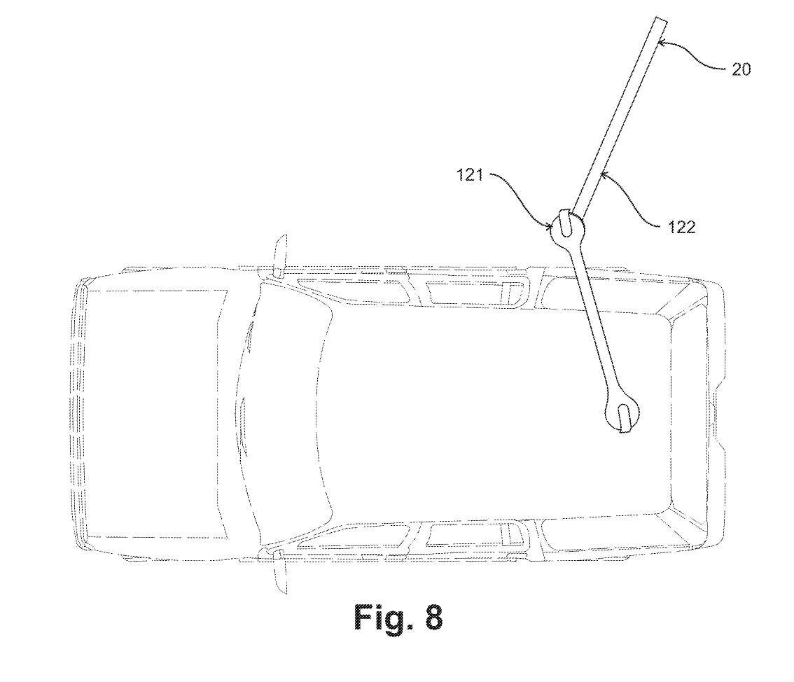

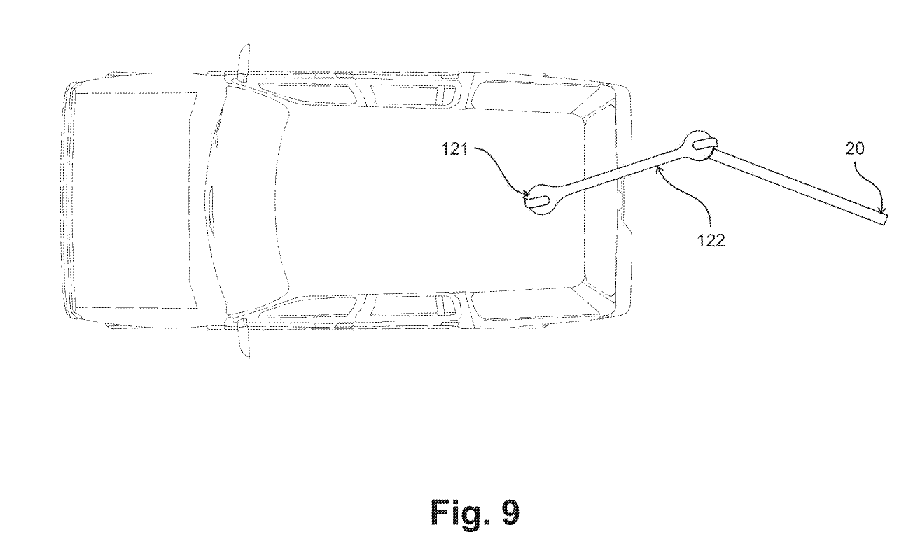

FIGS. 7, 8, and 9 depict a preferred embodiment of an image capture system according to the present invention using a swing arm extension 120 with one or more arms 122 as the extension device. The swing arm extension 120 can rotate to any appropriate angle about one or more pivots 121 to position a camera 20 to a desired position.

The drawings feature preferred embodiments that operate generally within a horizontal plane. However, other preferred embodiments of the invention are capable of deploying in other directions.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims. For example, one skilled in the art will appreciate that the extension device 10 can also comprise of alternative extensions such as an accordion extension, or a combination of the above embodiments such as a pivoting telescopic extension.

### LIST OF REFERENCE NUMERALS

10 extension device
11 distal end
12 proximal end
20 camera
22a scope of view
22b scope of view
23a center beam
23b center beam
100 sliding bar
101 bracket
110 telescopic extension
120 swing arm extension
121 pivot
122 arm

What is claimed is:

1. An image or video capture system mounted to a vehicle, comprising:
an extension device capable of moving between a retracted position and an extended position, the extension device having a proximal end and a distal end;
an attachment structure capable of attaching the extension device to the vehicle; and
a first camera located at the distal end, the first camera having a first scope of view, the first scope of view having a first center beam;
wherein the camera is positioned away from a body of the vehicle when the extension device is in the extended position.

2. The image or video capture system of claim 1, wherein the extension device is a sliding bar and the attachment structure is a bracket.

3. The image or video capture system of claim 2, wherein the bracket is capable of rotating about a pivot.

4. The image or video capture system of claim 3, further comprising:
a display device capable of displaying in real time the images captured by the first camera.

5. The image or video capture system of claim 4, further comprising:
a sensor capable of detecting a distance between the distal end and an obstruction;
wherein the image capture system will prevent deployment of the extension device if the distance is insufficient to properly deploy the extension device.

6. The image or video capture system of claim 5, further comprising:
a light located at the distal end.

7. The image or video capture system of claim 5, wherein the bracket is rotated such that the sliding bar is pointed in a direction toward which the vehicle will be moving.

8. The image or video capture system of claim 2, wherein the first center beam is pointed at the vehicle.

9. The image or video capture system of claim 2, wherein the first center beam is pointed at an angle toward the vehicle.

10. The image or video capture system of claim 2, further comprising:
a second camera on the sliding bar, the second camera having a second scope of view that partially intersects the first scope of view, the second scope of view having a second center beam;
a first image captured by the first camera;
a second image captured by the second camera;
an image processor capable of combining the first image and the second image to form a combined image; and
a display device capable of displaying in real time the combined image.

11. The image or video capture system of claim 10, wherein the first center beam is pointed at an angle toward the vehicle and the second center beam is pointed at an angle away from the vehicle.

12. The image or video capture system of claim 2, further comprising:
a second camera on the vehicle, the second camera having a second scope of view that intersects the first scope of view, the second scope of view having a second center beam;
a first image captured by the first camera;
a second image captured by the second camera;
an image processor capable of combining the first image and the second image to form a combined image; and
a display device capable of displaying in real time the combined image.

13. The image or video capture system of claim 1, wherein the extension device is a telescopic extension.

14. The image or video capture system of claim 1, wherein the extension device is a swing arm extension.

15. The image or video capture system of claim 1, wherein the first scope of view has at least a 180° view angle.

16. The image or video capture system of claim 1, wherein the first camera is positioned within the body of the vehicle when the extension device is in the retracted position.

17. The image or video capture system of claim 1, wherein the first camera is positioned adjacent to the body of the vehicle when the extension device is in the retracted position.

18. A method of capturing images or videos around a body of a vehicle, comprising the steps of:
providing an extension device with a first camera located on a distal end of the extension device, the first camera having a first center beam;
deploying the extension device from a retracted position to an extended position such that the camera is moved away from the body of the vehicle;
capturing images using the first camera.

19. The method of capturing images of claim 18, wherein portions of the body are visible in the images captured by the first camera.

20. The method of capturing images of claim 18, further comprising:
providing a second camera on the distal end of the extension device, the second camera having a second center beam;
pointing the first center beam toward the body of the vehicle, relative to the position of the first camera; and
pointing the second center beam away the body of the vehicle, relative to the position of the second camera.
